(19) United States
(12) Patent Application Publication
(10) Pub. No.: US 2010/0178420 A1
(43) Pub. Date: Jul. 15, 2010

(54) METHOD OF PREPARING CONDUCTIVE INK COMPOSITION FOR PRINTED CIRCUIT BOARD AND METHOD OF PRODUCING PRINTED CIRCUIT BOARD

(75) Inventors: Jong-Hee Lee, Suwon-si (KR); Jae-Myung Kim, Suwon-si (KR); Kyu-Nam Joo, Suwon-si (KR); So-Ra Lee, Suwon-si (KR); Jae-Sun Jeong, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/641,192

(22) Filed: Dec. 17, 2009

(30) Foreign Application Priority Data
Jan. 13, 2009 (KR) 10-2009-0002740

(51) Int. Cl. B05D 5/12; C09D 11/00

(52) U.S. Cl. 427/99.2; 106/31.92; 977/773

(57) ABSTRACT

Disclosed are a method of preparing a conductive ink composition for a flexible printed circuit (FPC) and a method of producing a printed circuit board using the conductive ink composition. This method includes preparing a first solution by mixing a Ag-containing compound and a fatty acid dispersion stabilizer in a polar solvent; preparing a second solution including Ag nanoparticles reduced from the Ag-containing compound by adding a reducing agent to the first solution; phase-transitioning the Ag nanoparticles into a nonpolar solvent by adding a phase-transition agent and a nonpolar solvent to the second solution including the Ag nanoparticles; and separating the nonpolar solvent including the Ag nanoparticles therefrom.

### CROSS-REFERENCE TO RELATED APPLICATIONS

This application claims priority to and the benefit of Korean Patent Application No. 10-2009-0002740 filed in the Korean Intellectual Property Office on Jan. 13, 2009, the entire contents of which are incorporated herein by reference.

### BACKGROUND OF THE INVENTION

1. Field of the Invention

This disclosure relates to a conductive ink composition for a flexible printed circuit board (FPC), and a method of producing the printed circuit board.

2. Description of the Related Art

A flexible printed circuit board (FPC) for various electronic devices such as a mobile phone, a PDA, a laptop computer, and the like, and also for a general electronic device for industry, office, or home has been manufactured in a lithography method and a deposition process. However, these processes are complex and require expensive equipment. In addition, as an electronic device becomes thinner and smaller, a flexible printed circuit (FPC) board requires higher density and higher integration. Accordingly, it needs to be minute, and have a narrow wire width and a narrow pitch between wires. Recently, research on a conductive metal ink for a flexible printed circuit (FPC) in a printing process such as an inkjet method has been undertaken. This conductive metal ink may include Ag nano-ink. The Ag nano-ink is prepared in the following method. First, nano-sized Ag particles are prepared from their atom units in a chemical reduction method, then separated and dried, and redispersed with a dispersing agent in a nonpolar organic solvent. In addition, the dispersion solution may be mixed with various additives to prepare Ag nano-ink considering viscosity, surface tension, wetness, and the like. The Ag nano-ink is used to form a fine wire in a common inkjet method. Herein, several to tens of nm nanoparticles are to be stably dispersed in a solvent. However, the chemical reduction method of preparing Ag nanoparticles has a problem of complexity, reduced dispersion during the redispersion, and agglomeration among particles due to large surface energy of the Ag nanoparticles. Accordingly, there is a problem of clogging a printing head nozzle.

### SUMMARY OF THE INVENTION

One aspect of this disclosure provides a method of preparing a conductive ink composition for a flexible printed circuit (FPC) having no agglomeration among the particles in a simple process.

Another aspect of this disclosure provides a method of producing a printed circuit board using the conductive ink composition.

The aspects of this disclosure are not limited to the above technical purposes, and a person of ordinary skill in the art can understand other technical purposes.

According to one aspect of this disclosure, provided is a method of preparing a conductive ink composition for a flexible printed circuit (FPC) including: preparing a first solution by mixing a Ag-containing compound and a fatty acid dispersion stabilizer in a polar solvent; adding a reducing agent to the first solution to prepare a second solution including Ag nanoparticles reduced from the Ag-containing compound; phase-transiting Ag into a nonpolar solvent by adding a phase-transition agent and a nonpolar solvent to the second solution including the Ag; and separating the nonpolar solvent including the Ag.

According to another aspect of this disclosure, provided is a method of producing a printed circuit board including coating the conductive ink composition on a substrate; heat-treating the substrate coated with the conductive ink composition at a temperature ranging from 170 to 300° C.

Hereinafter, further aspects of this disclosure will be described in detail.

Therefore, the method of preparing a conductive ink composition for a flexible printed circuit (FPC) may provide an ink composition with no agglomeration in a simple process. Since the ink composition has no problem of clogging a nozzle and the like, it can contribute to easily fabricating a flexible printed circuit (FPC).

### BRIEF DESCRIPTION OF THE DRAWING

FIG. 1 is a graph showing a particle diameter distribution of Ag nanoparticles in a conductive ink composition according to Example 1.

### DETAILED DESCRIPTION OF THE INVENTION

Exemplary embodiments of this disclosure will hereinafter be described in detail. However, these embodiments are only exemplary, and this disclosure is not limited thereto.

According to a first embodiment, a method of preparing a conductive ink composition for a flexible printed circuit (FPC) includes preparing a first solution by mixing a Ag-containing compound, a fatty acid dispersion stabilizer, and a polar solvent; preparing a second solution including Ag nanoparticles reduced from the Ag-containing compound by adding a reducing agent to the first solution; phase-transitioning the Ag nanoparticles into a nonpolar solvent by adding a phase-transition agent and a nonpolar solvent to the second solution including the Ag nanoparticles; and separating the nonpolar solvent including the Ag nanoparticles therefrom.

Hereinafter, the manufacturing method according to the first embodiment is illustrated in more detail.

A first solution is prepared by mixing a Ag-containing compound and a fatty acid dispersion stabilizer in a polar solvent.

The Ag-containing compound may be, for example, AgCl, AgNO₃, AgClO₄, Ag₂SO₄, AgBF₄, CH₃COOAg, or a combination thereof. The Ag-containing compound is dissolved in the first solution, dispersing Ag⁺ ions therein.

The fatty acid dispersion stabilizer may be, for example, a compound having a carbon-carbon double bond and a carboxyl group, and can be for example, oleic acid, sodium oleate, linoleic acid, erucic acid, stearic acid, or a combination thereof. In some embodiments, in the first solution, the carboxyl group (COOH) of the fatty acid dispersion stabilizer exists as a carboxylate (—COO⁻—).

The polar solvent may include water or alcohol. The alcohol may include, for example, methanol, ethanol, propanol, butanol, isopropyl alcohol, or a combination thereof. When the solvent is nonpolar, a Ag-containing compound has no or very little solubility and will likely not exist as Ag⁺ ions, which resultantly would not be reduced into Ag⁰ or into particles.

In some embodiments, the Ag-containing compound and the fatty acid dispersion stabilizer are mixed in a ratio ranging from about 1:0.06 to about 1:0.15 wt %. When they are mixed within the ratio, Ag⁺ ions may have appropriate dispersive power, easily producing nano-size Ag particles. In some embodiments, Ag⁺ ions may be prepared into Ag nanoparticles with a uniform diameter distribution at an appropriate reaction speed.

Next, a second solution is prepared by adding a reducing agent to the first solution.

The reducing agent may include, for example, sodium borohydrate, L-ascorbic acid, oxalic acid, a sodium amalgam, or a combination thereof.

This reducing agent reduces Ag⁺ ions into Ag⁰ in the first solution. Thus, the Ag⁰ exists as Ag nanoparticles in the second solution. In addition, the produced Ag nanoparticles are strongly absorbed with the carbon-carbon double bond of the fatty acid dispersion stabilizer, In some embodiments, the Ag nanoparticlers are capped by the fatty acid dispersion stabilizer. Accordingly, the Ag nanoparticles become stable by a hydrophilic group (such as a carboxylate group) in terms of particle dispersion.

Next, a phase-transition agent and a nonpolar solvent are added to the second solution including the Ag nanoparticles. The phase-transition agent plays a role of transitioning the carboxylate group (—COO⁻—) of the fatty acid dispersion stabilizer capping the Ag nanoparticles into a carboxyl group (—COOH). Herein, the phase-transition agent provides H⁺ ions to transition the carboxylate group into the carboxyl group and thereby make it more soluble in a nonpolar solvent.

The phase-transition agent may be, for example, H₃PO₄, NaH₂PO₄, H₂CO₃, NaHCO₃, or a combination thereof. When an amine and the like which do not provide H⁺ as a phase-transition agent is used, it may not transition the carboxylate group (—COO⁻—) of a fatty acid dispersion stabilizer into a carboxyl group (—COOH).

In some embodiments, the fatty acid dispersion stabilizer and the phase-transition agent are mixed for a smooth phase transition in a ratio ranging from about 1:4 to about 1:6 wt %.

The nonpolar solvent may be for example, toluene, tetradecane, cyclohexane, chloroform, dioxane, or a combination thereof. The amount of the nonpolar solvent used may be appropriately regulated according to the knowledge of one skilled in the art.

The second solution including Ag nanoparticles is polar and has no or very little miscibility with a nonpolar solvent. Accordingly, in some embodiments, the Ag nanoparticles generally do not move toward the nonpolar solvent but have a phase-transition toward it by adding a phase-transition agent.

When the phase-transition agent is added, the functional group of a fatty acid dispersion stabilizer existing as carboxylate (—COO⁻—) in the first solution is converted to a carboxyl group (COOH). The converted carboxyl group includes a hydrophilic head and a hydrophobic tail. Accordingly, the hydrophilic head of a carboxyl group is strongly absorbed on the surface of Ag nanoparticles in a nonpolar solvent. The hydrophobic tail has affinity for a nonpolar organic solvent, and thereby a phase transition tendency toward the nonpolar solvent. When the fatty acid dispersion stabilizer has a phase transition toward the nonpolar solvent, the Ag nanoparticles absorbed with the carboxyl group of a fatty acid dispersion stabilizer also move toward the nonpolar solvent.

The nonpolar solvent including Ag nanoparticles is separated to prepare a conductive ink composition. The conductive ink composition may further include a viscosity-controlling agent and a wetting agent to improve dispersion and control viscosity. This viscosity-controlling agent may include, for example, BYK108® (BYK Additive & Instruments, Wesel, Germany), BYK-192® (made by BYK Additive & Instruments, Wesel, Germany), Anti-Terra-U® (made by BYK Additive & Instruments, Wesel, Germany), or a combination thereof. The wetting agent may include, for example, glycerol, ethylene glycol, propylene glycol, or a combination thereof.

In the conductive ink composition, Ag has an average particle diameter ranging from about 52 to about 54 nm and has a standard deviation ranging from about 1.9 to about 2.1. In addition, the Ag is uniformly dispersed. Furthermore, the conductive ink composition includes Ag in an amount of from about 55 to about 60 wt %, which is a high concentration compared with a conventional amount ranging from 30 to 50 wt %. Accordingly, it can be effectively used to fabricate a fine wire in a flexible printed circuit (FPC).

According to one embodiment, the conductive ink composition may be very useful to fabricate a flexible printed circuit (FPC).

Another embodiment provides a method of fabricating a flexible printed circuit (FPC) using the conductive ink composition.

A conductive ink composition according to one embodiment is coated on a substrate.

The substrate for fabricating a flexible printed circuit (FPC) may include any one of, for example, a resin film, a glass substrate or a substrate made of polytetrafluoroethylene or polyimide.

The substrate coated with the ink composition is heat-treated at a temperature ranging from about 170 to about 300° C., or a temperature ranging from about 190 to about 250° C., thereby fabricating a flexible printed circuit (FPC). The heat treatment removes residual carbon from an organic material and forms fine Ag wires on the substrate. Since the heat treatment process is performed at a temperature of about 300° C. or lower, there is no time loss due to the heat treatment, improving productivity and having no overfiring problem associated with heat treatment at a higher temperature. The heat treatment may be performed under an air atmosphere for from about 20 to about 40 minutes.

The following examples illustrate this disclosure in more detail. These examples, however, should not in any sense be interpreted as limiting the scope of this disclosure.

### Example 1

A first solution was prepared by dissolving 14.4 parts by weight of AgNO₃ and 1.25 parts by weight of oleic acid in 70 parts by weight of distilled water. Next, a second solution was prepared by dissolving 16.6 parts by weight of NaBH₄ in 30 parts by weight of distilled water. The second solution was added to the first solution. The mixture was reacted at room temperature, producing Ag nanoparticles. 10 parts by weight of toluene was poured into aqueous Ag sol for phase separation, and then 6 parts by weight of H₃PO₄ as a phase-transition agent was added thereto. The resulting mixture was reacted at room temperature, strongly agitated together for 10 minutes, and allowed to stand for 20 minutes to transfer Ag nanoparticles dispersed in an aqueous solution toward toluene. Next, the toluene Ag sol was separated from the aqueous solution, and 0.03 parts by weight of BYK108 and 0.2 parts by weight of glycerol were added thereto, preparing a conductive ink composition in which Ag nanoparticles were dispersed in a nonpolar organic solvent.

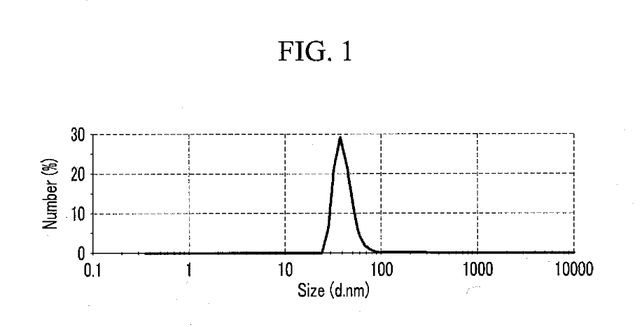

In the conductive ink composition, the Ag nanoparticles were measured regarding particle diameter. FIG. 1 shows their distribution. As shown in FIG. 1, the Ag nanoparticles in the conductive ink composition had an average particle diameter of about 53 nm.

While this disclosure has been described in connection with what is presently considered to be practical exemplary embodiments, it is to be understood that the present embodiments are not limited to the disclosed embodiments, but, on the contrary, are intended to cover various modifications and equivalent arrangements included within the spirit and scope of the appended claims. Therefore, the aforementioned embodiments should be understood to be exemplary but not limiting this disclosure in any way.

What is claimed is:

1. A method of preparing a conductive ink composition, comprising:
preparing a first solution by mixing a Ag-containing compound and a fatty acid dispersion stabilizer in a polar solvent;
preparing a second solution comprising Ag nanoparticles reduced from the Ag-containing compound by adding a reducing agent to the first solution;
phase-transitioning the Ag nanoparticles into a nonpolar solvent by adding a phase-transition agent and a nonpolar solvent to the second solution comprising the Ag nanoparticles; and
separating the nonpolar solvent comprising Ag nanoparticles.

2. The method of claim 1, wherein the Ag-containing compound is selected from AgCl, AgNO₃, AgClO₄, Ag₂SO₄, Ag₂BF₄, CH₃COOAg, or a combination thereof.

3. The method of claim 1, wherein the fatty acid dispersion stabilizer is a compound having a carbon-carbon double bond and a carboxyl group.

4. The method of claim 1, wherein the fatty acid dispersion stabilizer is selected from oleic acid, sodium oleate, linolenic acid, erucic acid, stearic acid, or a combination thereof.

5. The method of claim 1, wherein the reducing agent is selected from sodium borohydrate, L-ascorbic acid, oxalic acid, a sodium amalgam, or a combination thereof.

6. The method of claim 1, wherein the phase-transition agent is selected from H₃PO₄, NaH₂PO₄, H₂CO₃, NaHCO₃, or a combination thereof.

7. The method of claim 1, wherein the nonpolar solvent is selected from toluene, tetradecane, cyclohexane, chloroform, dioxane, or a combination thereof.

8. The method of claim 1, wherein the polar solvent is water or alcohol.

9. The method of claim 1, wherein the Ag-containing compound and the fatty acid dispersion stabilizer are mixed in a ratio of from about 1:0.06 to about 1:0.15 wt %.

10. A method of producing a printed board, comprising:
coating a conductive ink composition on a substrate; and
heat-treating the coated substrate at a temperature of from about 170 to about 300° C. wherein the conductive ink composition is prepared by:
preparing a first solution by mixing a Ag-containing compound and a fatty acid dispersion stabilizer in a polar solvent;
preparing a second solution comprising Ag nanoparticles reduced from the Ag-containing compound by adding a reducing agent to the first solution;
phase-transitioning the Ag nanoparticles into a nonpolar solvent by adding a phase-transition agent and a nonpolar solvent to the second solution comprising the Ag nanoparticles; and
separating the nonpolar solvent comprising Ag nanoparticles.

11. The method of claim 10, wherein the heat treatment is performed at a temperature of from about 190 to about 250° C.

12. The method of claim 10, wherein the Ag-containing compound is selected from AgCl, AgNO₃, AgClO₄, Ag₂SO₄, AgBF₄, CH₃COOAg, or a combination thereof.

13. The method of claim 10, wherein the fatty acid dispersion stabilizer is a compound having a carbon-carbon double bond and a carboxyl group.

14. The method of claim 10, wherein the fatty acid dispersion stabilizer is selected from oleic acid, sodium oleate, linolenic acid, erucic acid, stearic acid, or a combination thereof.

15. The method of claim 10, wherein the reducing agent is selected from sodium borohydrate, L-ascorbic acid, oxalic acid, a sodium amalgam, or a combination thereof.

16. The method of claim 10, wherein the phase-transition agent is selected from H₃PO₄, NaH₂PO₄, H₂CO₃, NaHCO₃, or a combination thereof.

17. The method of claim 10, wherein the nonpolar solvent is selected from toluene, tetradecane, cyclohexane, chloroform, dioxane, or a combination thereof.

18. The method of claim 10, wherein the polar solvent is water or alcohol.

19. The method of claim 10, wherein the Ag-containing compound and the fatty acid dispersion stabilizer are mixed in a ratio of from about 1:0.06 to about 1:0.15 wt %.

20. The method of claim 10, wherein the Ag-containing compound is AgNO₃.
